(19) United States
(12) Patent Application Publication
(10) Pub. No.: US 2017/0007990 A1
(43) Pub. Date: Jan. 12, 2017

(54) HONEYCOMB DENITRATION CATALYST FOR FLUE GAS AT 400°C-600°C AND PREPARATION METHOD THEREOF

(71) Applicants: Tongji University, Shanghai (CN); Shanghai Tongji Clearon Environmental Protection Equipment Engineering Co. Ltd., Shanghai (CN)

(72) Inventors: Jianwei FAN, Shanghai (CN); Hongyang MIN, Shanghai (CN); Xianqiang RAN, Shanghai (CN); Yu SUN, Shanghai (CN); Rongxing PAN, Shanghai (CN); Liyin ZOU, Shanghai (CN); Xu JIANG, Shanghai (CN); Dandan LI, Shanghai (CN); Wangyuan CHEN, Shanghai (CN); Minjun CHEN, Shanghai (CN)

(21) Appl. No.: 15/275,617

(22) Filed: Sep. 26, 2016

Related U.S. Application Data
(63) Continuation of application No. PCT/CN2014/088193, filed on Oct. 9, 2014.

(30) Foreign Application Priority Data
Apr. 24, 2014 (CN) 201410168161.1

(51) Int. Cl. B01J 29/48; B01J 29/16; B01D 53/86; B01J 37/00; B01J 37/02; B01J 29/78; B01J 37/04

(52) U.S. Cl. CPC B01J 29/48; B01J 29/7807; B01J 29/163; B01J 29/166; B01J 37/04; B01J 37/0009; B01J 37/0215; B01J 37/0236; B01D 53/8628; B01D 2255/504; B01D 2255/2092; B01D 2255/20769; B01D 2255/2065; B01D 2255/20738; B01D 2255/20776; B01D 2255/1021; B01D 2255/1023

(57) ABSTRACT

A honeycomb denitration catalyst used for flue gas at 400° C.-600° C. and preparation method thereof. The honeycomb denitration catalyst includes a catalyst coating and a honeycomb ceramic, where a slurry of the catalyst coating is made from components having the following mass percentages: 15%-25% of a zeolite, 5%-10% of a γ-alumina, 5%-10% of a catalyst auxiliary agent, 5% of a binder, and 50%-70% of deionized water. The honeycomb ceramic is soaked repeatedly into the slurry of the catalyst coating. After the soaking is completed, the obtained product is dried and calcined to obtain the honeycomb denitration catalyst. The honeycomb denitration catalyst contains a catalyst auxiliary agent and has excellent denitration activity at high temperatures, sulphur-resistance and water-tolerance ability, stability and NOₓ removing ability.

### TECHNICAL FIELD

The present invention belongs to the field of environmental materials, environmental catalysis and environmental protection technology and relates to a honeycomb denitration catalyst used for flue gas at 400° C.-600° C. that is discharged by coal-bed methane power station and preparation method thereof.

### BACKGROUND

Emission of nitrogen oxide has become one of the major causes for environmental pollution and thus results in a series of environmental problems, such as photochemical smog, acid rain, ozone layer depletion and greenhouse effect, etc. Currently, selective catalytic reduction is one of the most effective ways to remove nitrogen oxide, wherein it is essential to select the types of catalysts.

Many scholars at home and abroad have made extensive and systematic studies on catalyst systems, including vanadium-titanium based system, copper-manganese based system, etc. At present, most of the industrially applied ammonia selective catalytic reduction catalyst (SCR catalyst) are under denitration treatment at a temperature below 450° C. because their denitration effect drastically decreases at the temperature of over 450° C. and even no denitration effect is produced. However, the exhaust gases discharged by coal-bed methane power stations are at a temperature of 500° C. or so, leading to such results that the denitration ability of commonly used catalysts are suppressed at such high temperatures. Accordingly, it determines the effects of energy conservation and emission reduction of enterprises that discharge high-temperature exhausted gas such as coal-bed methane power station how to develop novel catalysts for high-temperature exhausted NOₓ gas without the need to exchange heat for the purpose of lowering the temperatures and at the same time to make the current catalyst to gain higher catalytic activity and higher stability. Currently, it remains a top priority for enterprises like coal-bed methane power station to study and develop novel high-temperature denitration catalysts.

### SUMMARY OF THE INVENTION

In order to solve such problem that the existing denitration catalyst becomes deactivated under high temperature, the present invention provides a honeycomb denitration catalyst used for flue gas at high temperatures and preparation method thereof.

To achieve the above object, the present invention adopts the following technical schemes:

The present invention has obtained a denitration catalyst having excellent denitration activity at high temperatures, sulphur-resistance and water-tolerance ability, high stability and good NOₓ removing performance through the addition of a catalyst auxiliary agent on the basis of previous studies.

A honeycomb denitration catalyst used for flue gas at 400° C.- 600° C. comprises a catalyst coating and a honeycomb ceramic, wherein the catalyst coating is coated on surfaces of the honeycomb ceramic and the honeycomb ceramic functions as a carrier, wherein the catalyst coating is made from components in slurry form having the following mass percentages:

| | |
|---|---|
| a zeolite | 15%-25%, |
| a γ-alumina (γ-aluminum oxide) | 5%-10%, |
| a catalyst auxiliary agent | 5%-10%, |
| a binder | 5%, |
| deionized water | 50-70%. |

The catalyst coating accounts for 8%-15% of the total mass of the honeycomb denitration catalyst.

The zeolite is selected from the group consisting of one or more of ZSM-5 type zeolite molecular sieve, A-type zeolite molecular sieve, X-type zeolite molecular sieve or Y-type zeolite molecular sieve.

The catalyst auxiliary agent is selected from the group consisting of one or more of ammonium molybdate, cerium nitrate, ferrous chloride, ammonium tungstate, chloroplatinic acid or palladium nitrate.

The binder is selected from an inorganic binder or an organic binder.

The inorganic binder is nitrate and can be preferably selected from the group consisting of one or more of cerium nitrate or ferric nitrate.

The organic binder is polyvinyl alcohol.

The denitration catalyst is a honeycomb catalyst whose denitration effect can arrive at above 90% under high temperature (400° C.˜600° C.).

A method for preparing a honeycomb denitration catalyst used for flue gas at 400° C.-600° C. comprises following steps:
(1) mixing 15%-25% of a zeolite, 5%-10% of a γ-alumina, 5%-10% of a catalyst auxiliary agent, 5% of a binder and 50-70% of deionized water in mass percentages in line with the above percentages of components to obtain a mixture and providing the mixture a stir in a mixer to reach the extent of homogeneity;
(2) transferring the mixed solution obtained from step (1) into a ball mill and obtaining a slurry of a catalyst coating after sufficient ball-milling;
(3) soaking a honeycomb ceramic repeatedly into the slurry of the catalyst coating and removing excessive slurry of the catalyst coating from surfaces of the honeycomb ceramic by high pressure air blowing and sweeping method; and
(4) drying and calcining the coated honeycomb ceramic obtained from step (3) to obtain the honeycomb denitration catalyst used for flue gas at 400° C.-600° C.

The ball-milling time in step (2) is 24 to 72 hours.

The soaking time in step (3) is 5 to 20 minutes.

The conditions for drying and calcining in step (4) is the following: drying at 120° C. for 12 hours, and then calcining at 500° C. to 550° C. for 5 hours.

The equation to calculate the loading capacity of the honeycomb ceramic is shown below:

W=(m₁−m₀)/m₀×100%.

In the equation, W is the loading capacity of the honeycomb ceramic (%), m₀ is the mass of the blank honeycomb ceramic before being coated with the catalyst coating (g), m₁ is the mass of the honeycomb ceramic after being coated with the catalyst coating and calcined (g).

The present invention has the following beneficial effects:

The catalyst coating prepared by this present invention has such characteristics as high loading capacity, homogeneous coating and strong binding ability between the catalyst coating and the honeycomb ceramic as a carrier. The catalyst coating exhibits very high denitration activity at temperatures ranging from 400 ° C. to 600° C. (conversion rate of NO is greater than 90%) and good tolerance to SO₂ and water vapor.

### DETAILED DESCRIPTION

Further description of the present invention has been made in connection with the following examples.

### Example 1

(1) Providing 15 g of a ZSM-5 type zeolite molecular sieve, 5 g of a γ-alumina, 5 g of a catalyst auxiliary agent (including ammonium molybdate, cerium nitrate, ferrous chloride, ammonium tungstate and chloroplatinic acid in such mole ratio as Mo:Ce:Fe:W:Pt=60:200:80:120:1), 5 g of a binder (ferric nitrate) and 70 g of deionized water in line with such mass percentage as 15% of a zeolite, 5% of a γ-alumina, 5% of a catalyst auxiliary agent, 5% of a binder and 70% of deionized water to obtain a mixture and providing the mixture a stir in a mixer to make it reach the extent of homogeneity.

(2) Transferring the mixed solution obtained from step (1) to a ball mill and obtaining a slurry of a catalyst coating after sufficient ball-milling, the ball-milling time is 24 hours.

(3) Soaking a honeycomb ceramic repeatedly into the slurry of the catalyst coating and the soaking time is 5 minutes. After that, removing excessive slurry of the catalyst coating from surfaces of the honeycomb ceramic by high pressure air blowing and sweeping method.

(4) Drying the coated honeycomb ceramic at 120° C. for 12 hours and then calcining it at 500° C. for 5 hours to obtain the honeycomb denitration catalyst; wherein, the catalyst coating accounts for 8% of the total mass of the honeycomb denitration catalyst.

It is demonstrated by the mock denitration test that when the volume concentration of NO is 1000 ppm, NH₃/NO=1, oxygen concentration is 5%, air flow rate is 10000 h⁻¹, denitration activity of the honeycomb denitration catalyst reach 90% at 400° C.

### Example 2

(1) Providing 25 g of a A-type zeolite molecular sieve, 10 g of a γ-alumina, 10 g of a catalyst auxiliary agent (including ammonium molybdate, cerium nitrate, ferrous chloride, ammonium tungstate, chloroplatinic acid and palladium nitrate in such mole ratio as Mo:Ce:Fe:W:Pt:Pd=20:160:120:140:1:1), 5 g of a binder (cerium nitrate) and 50 g of deionized water in line with such mass percentage as 25% of a zeolite, 10% of a γ-alumina, 10% of a catalyst auxiliary agent, 5% of a binder and 50% of deionized water to obtain a mixture and providing the mixture a stir in a mixer to the extent of homogeneity.

(2) Transferring the mixed solution obtained from step (1) to a ball mill and obtaining a slurry of a catalyst coating after sufficient ball-milling, the ball-milling time is 36 hours.

(3) Soaking a honeycomb ceramic repeatedly into the slurry of the catalyst coating and the soaking time is 10 minutes. After that, removing excessive slurry of the catalyst coating from surfaces of the honeycomb ceramic by high pressure air blowing and sweeping method.

(4) Drying the coated honeycomb ceramic at 120° C. for 12 hours and then calcining it at 550° C. for 5 hours to obtain the honeycomb denitration catalyst; wherein, the catalyst coating accounts for 12% of the total mass of the honeycomb denitration catalyst.

It is demonstrated by the mock denitration test that when the volume concentration of NO is 1000 ppm, NH₃/NO=1:1.1, oxygen concentration is 5%, air flow rate is 10000 h⁻¹, denitration activity of the honeycomb denitration catalyst reach 90% at 450° C.

Example 3

(1) Providing 20 g of a X-type zeolite molecular sieve, 7.50 g of a γ-alumina, 7.5 g of a catalyst auxiliary agent (including ammonium molybdate, cerium nitrate, ferrous chloride, ammonium tungstate, chloroplatinic acid and palladium nitrate in such mole ratio as Mo:Ce:Fe:W:Pt:Pd=60:200:160:160:1:1), 5 g of a binder (including cerium nitrate and ferric nitrate in such a mole ratio as Ce:Fe=5:1) and 60 g of deionized water in line with such mass percentage as 20% of a zeolite, 7.5% of a γ-alumina, 7.5% of a catalyst auxiliary agent, 5% of a binder and 60% of deionized water to obtain a mixture and providing the mixture a stir in a mixer to the extent of homogeneity.

(2) Transferring the mixed solution obtained from step (1) to a ball mill and obtaining a slurry of a catalyst coating after sufficient ball-milling, the ball-milling time is 48 hours.

(3) Soaking a honeycomb ceramic repeatedly into the slurry of the catalyst coating and the soaking time is 15 minutes. After that, removing excessive slurry of the catalyst coating from surfaces of the honeycomb ceramic by high pressure air blowing and sweeping method.

(4) Drying the coated honeycomb ceramic at 120° C. for 12 hours and then calcining it at 600° C. for 5 hours to obtain the honeycomb denitration catalyst; wherein, the catalyst coating accounts for 14% of the total mass of the honeycomb denitration catalyst.

It is demonstrated by the mock denitration test that when the volume concentration of NO is 1000ppm, NH₃/NO=1:1.2, oxygen concentration is 5%, air flow rate is 10000 h⁻¹, denitration activity of the honeycomb denitration catalyst reach 90% at 500° C.

Example 4

(1) Providing 25 g of a Y-type zeolite molecular sieve, 10 g of a γ-alumina, 5 g of a catalyst auxiliary agent (including ammonium molybdate, cerium nitrate, ferrous chloride, ammonium tungstate and palladium nitrate in such mole ratio as Mo:Ce:Fe:W:Pd=60:160:120:160:1), 5 g of a binder (including cerium nitrate and ferric nitrate in such a mole ratio as Ce:Fe=1:1) and 55 g of deionized water in line with such mass percentage as 25% of a zeolite, 10% of a γ-alumina, 5% of a catalyst auxiliary agent, 5% of a binder and 55% of deionized water to obtain a mixture and providing the mixture a stir in a mixer to an extent of homogeneity.

(2) Transferring the mixed solution obtained from step (1) to a ball mill and obtaining a slurry of a catalyst coating after sufficient ball-milling, the ball-milling time is 72 hours.

(3) Soaking a honeycomb ceramic repeatedly into the slurry of the catalyst coating and the soaking time is 20 minutes. After that, removing excessive slurry of the catalyst coating from surfaces of the honeycomb ceramic by high pressure air blowing and sweeping method.

(4) Drying the coated honeycomb ceramic at 120° C. for 12 hours and then calcining it at 500° C. for 5 hours to obtain the honeycomb denitration catalyst; wherein, the catalyst coating accounts for 15% of the total mass of the honeycomb denitration catalyst.

It is demonstrated by the mock denitration test that when the volume concentration of NO is 1000ppm, NH₃/NO=1 oxygen concentration is 5%, air flow rate is 10000 h⁻¹, denitration activity of the honeycomb denitration catalyst reach 90% at 600° C.

The above descriptions of examples are conducive for ordinary technicians of the present technical field to understand and exploit the invention. Persons skilled in the art of the present field can easily make various amendments to the above examples and apply the general principle illustrated in here into other examples without the effort of inventive work.

Therefore, the present invention is not confined or limited to the examples described herein. Any improvements and modifications conducted by persons skilled in the art of the present field according to the present invention and without going beyond the scope of the present invention shall be included in the extent of protection of the present invention.

What is claimed:

1. A honeycomb denitration catalyst used for flue gas at 400° C.-600° C., comprising a catalyst coating and a honeycomb ceramic, wherein the catalyst coating is deposited on surfaces of the honeycomb ceramic, the catalyst coating is made from components having the following mass percentages:
a zeolite in an amount of 15%-25%;
a γ-alumina in an amount of 5%-10%;
a catalyst auxiliary agent in an amount of 5%-10%;
a binder in an amount of 5%; and
deionized water in an amount of 50-70%.

2. The honeycomb denitration catalyst of claim 1, wherein the catalyst coating is 2%-15% of the total mass of the honeycomb denitration catalyst.

3. The honeycomb denitration catalyst of claim 1, wherein the zeolite is selected from the group consisting of ZSM-5 type zeolite molecular sieve, A-type zeolite molecular sieve, X-type zeolite molecular sieve, Y-type zeolite molecular sieve, and any combinations thereof

4. The honeycomb denitration catalyst of claim 1, wherein the catalyst auxiliary agent is selected from the group consisting of ammonium molybdate, cerium nitrate, ferrous chloride, ammonium tungstate, chloroplatinic acid, palladium nitrate, and any combinations thereof.

5. The honeycomb denitration catalyst of claim 1, wherein the binder is an inorganic binder or an organic binder.

6. The honeycomb denitration catalyst of claim 5, wherein the inorganic binder is nitrate.

7. The honeycomb denitration catalyst of claim 6, wherein the inorganic binder is cerium nitrate and/or ferric nitrate; and
the organic binder is polyvinyl alcohol.

8. A method for preparing a honeycomb denitration catalyst for flue gas at 400° C.-600° C., comprising:
(1) mixing 15%-25% by mass of a zeolite, 5%-10% by mass of a γ-alumina, 5%-10% by mass of a catalyst auxiliary agent, 5% by mass of a binder and 50-70% by mass of deionized water in mass percentages to obtain a mixture and providing the mixture to a stirring mixer to reach an extent of homogeneity;
(2) transferring the mixed solution obtained from step (1) into a ball mill and, after a sufficient ball-milling time, obtaining a slurry of a catalyst coating;
(3) soaking a honeycomb ceramic repeatedly into the slurry of the catalyst coating and removing excessive slurry of the catalyst coating from surfaces of the honeycomb ceramic by high pressure air blowing and sweeping method; and
(4) drying and calcining the coated honeycomb ceramic obtained from step (3) to obtain the honeycomb denitration catalyst for flue gas at 400° C.- 600° C.

9. The method of claim 8, wherein the ball-milling time in step (2) is 24 to 72 hours.

10. The method of claim 8, wherein the soaking time in step (3)is 5 to 20 minutes.

11. The method of claim 8, wherein the drying and calcining in step (4) further comprise: drying at 120° C. for 12 hours, and then calcining at 500° C. to 550° C. for 5 hours.
